(19) United States
(12) Patent Application Publication
(10) Pub. No.: US 2026/0010829 A1
(43) Pub. Date: Jan. 8, 2026

(54) CLASSIFICATION DEVICE, CLASSIFICATION METHOD, AND CLASSIFICATION PROGRAM

(71) Applicant: KOKUSAI DENKI ELECTRIC INC., Tokyo (JP)

(72) Inventors: KEITA YAMANE, TOKYO (JP); KEIGO HASEGAWA, TOKYO (JP); Goichi ONO, Tokyo (JP); AKIRA KITAYAMA

(21) Appl. No.: 19/105,800

(22) PCT Filed: Apr. 17, 2023
(86) PCT No.: PCT/JP2023/015350

§ 371 Date: Feb. 22, 2025

(30) Foreign Application Priority Data
Sep. 13, 2022 (JP) 2022-145597

(51) Int. Cl. G06N 20/00

(52) U.S. Cl. CPC G06N 20/00

(57) ABSTRACT

This classification device executes: a calculation process for calculating a first training result evaluation value indicating the extent to which data being classified, to which no correct-answer label is attached, contributes to supplemental training of a prediction model that is capable of accessing a training dataset in which correct-answer labels are attached and that is trained using the training dataset, the calculation being carried out on the basis of a first degree of uncertainty indicating the level of ambiguity in a first prediction result outputted as a result of having inputted the data being classified to the prediction model; a classification process for classifying the data being classified as either one of supplemental training data or non-supplemental training data for the prediction model, the classification being carried out on the basis of the first training result evaluation value calculated through the calculation process; a setting process for configuring a setting so that a correct-answer label can be attached to the supplemental training data classified through the classification process; and a supplementation process for supplementing the training dataset with the supplemental training data to which the correct-answer label was attached in the setting process.

### INCLUSION BY REFERENCE

This application claims priority to Japanese Patent Application No. 2022-145597 filed on Sep. 13, 2022, the entire contents of which are incorporated herein by reference.

### TECHNICAL FIELD

The present disclosure relates to a classification device, a classification method, and a classification program that classify data.

### BACKGROUND

A classification device is a device that learns a model using a known learning device such as a neural network, and outputs prediction based on inputted data. The classification device includes a model that performs prediction based on the inputted data, and a learning device that generates the model using a known device such as a neural network or the like. For example, a technique in which an image captured by a camera is inputted to output an object in the image is known.

Since the classification device can improve the predictive performance of the model by learning various patterns of data, a user needs to select data with a high learning effect that contributes to the improvement of the model's performance from a large amount of data outputted from a sensor, a camera, a user interface, or the like. Further, the model learned using the classified data needs to meet the requirements for predictive performance.

However, when the amount of data is large, the time and human cost required for a user to select data with a high learning effect becomes enormous. Accordingly, the time and human cost required to generate the model increase.

Further, in order to determine the level of learning effect, it is necessary to recognize in advance the change in the performance of the model when it is learned with various data. Hence, a classification operator needs to have advanced know-how.

Therefore, a technique that automates the above-described data classification operation by introducing an index indicating the level of learning effect of each data and selecting data with a high learning effect based on the index is known (see, e.g., Patent Document 1 to be described below).

The image inspection device of Patent Document 1 calculates a stability evaluation value indicating the stability in determining whether multiple images are defective or non-defective, and presents candidate images to be additionally learned by a classifier based on the stability evaluation value to a user. The image inspection device accepts user's designation of additional learning images among the presented candidate images. The image inspection device additionally learns the additional learning images designated by the user as defective images or non-defective images, and updates the classifier.

Further, although there are various methods for calculating an index indicating the level of learning effect, they may not correlate with the actual learning effect. For example, there is a method for calculating uncertainty of a prediction result outputted by a model, and selecting data with high uncertainty as data with a high learning effect (see, e.g., Patent Document 2 to be described below).

The information processing device of Patent Document 2 includes a division part, a calculation part, and an integration part. The division part divides input data to be processed, which is inputted to output a processing result, into multiple partial data. The calculation part executes processing for each of the multiple partial data, and calculates multiple uncertainties indicating a degree of doubt of the processing. The integration part integrates the multiple uncertainties and outputs it as the uncertainty of the input data.

### PRIOR ART DOCUMENTS

### Patent Documents

Patent document 1: Japanese Laid-open Patent Publication No. 2020-187072

Patent document 2: Japanese Laid-open Patent Publication No. 2021-149818

### SUMMARY

### Problems to be Resolved by the Invention

However, the classification target data includes data with a low learning effect, such as outlier data deviated from the population and data to which a correct answer label indicating an ideal prediction result required for model learning is mistakenly attached.

The above-described high uncertainty is obtained from the data with a low learning effect. Hence, in a method for selecting data with high uncertainty as data with a high learning effect, data with a low learning effect is mistakenly classified and learned, thereby deteriorating the model performance.

The present disclosure is intended to improve the classification accuracy of data to be used for additional learning.

### Means for Solving the Problems

A classification device, which is an aspect of the invention disclosed in this application, includes a processor that executes a program and a storage device that stores the program, and is accessible to a group of learning data to which a correct answer label is attached. The processor is characterized by executing: a calculation process for calculating a first learning effect evaluation value indicating the extent to which the classification target data contributes to additional learning of the prediction model based on first uncertainty indicating a level of ambiguity of a first prediction result outputted as a result of inputting classification target data to which the correct answer label is not attached to a prediction model learned with the group of learning data; a classification process for classifying the classification target data as additional learning data or non-additional learning data for the prediction model based on the first learning effect evaluation value calculated by the calculation process; a setting process for performing setting such that the correct answer label is attached to the additional learning data classified by the classification process; and an addition process for adding the additional learning data to which the correct answer label is attached by the setting process to the group of learning data.

### Effect of the Invention

In accordance with a representative embodiment of the present disclosure, the classification accuracy of data to be used for additional learning can be improved. Problems, configurations, and effects other than those described above will be clarified by the following description of the embodiments.

### BRIEF DESCRIPTION OF THE DRAWINGS

FIG. 1 is a block diagram showing an example of a hardware configuration of a classification device.

FIG. 2 is a block diagram showing an example of a functional configuration of a classification device.

FIG. 3 is a block diagram showing a specific functional configuration of a model generation part.

FIG. 4 is a block diagram showing a specific functional configuration of a data classification part according to Test example 1.

FIG. 5 is an explanatory diagram showing a specific example of a division learning part and a conversion formula generation part.

FIG. 6 is a flowchart showing an example of a sequence of a data classification process performed by a classification device according to Test example 1.

FIG. 7 is a flowchart showing an example of a sequence of a conversion formula generation process performed by a division learning part and a conversion formula generation part.

FIG. 8 is a block diagram showing a specific functional configuration of a data classification part according to Test example 2.

FIG. 9 is a flowchart showing an example of a sequence of a data classification process performed by a classification device according to Test example 2.

FIG. 10 is a flowchart showing an example of a specific sequence of a determination process (step S900) performed by a determination part.

### DETAILED DESCRIPTION

### Test Example 1

### <Example of Hardware Configuration of Classification Device>

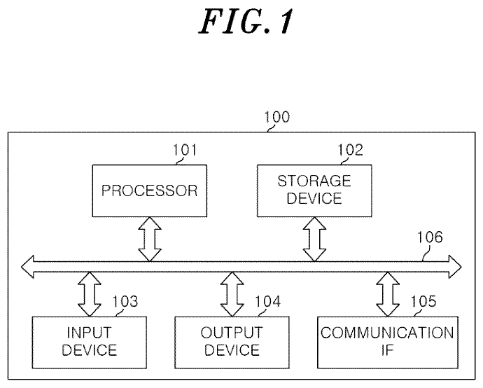

FIG. 1 is a block diagram showing an example of a hardware configuration of a classification device. The classification device 100 has a processor 101, a storage device 102, an input device 103, an output device 104, and a communication interface (communication IF) 105. The processor 101, the storage device 102, the input device 103, the output device 104, and the communication IF 105 are connected by a bus 106. The processor 101 controls the classification device 100. The storage device 102 is a working area for the processor 101. The storage device 102 is a non-temporary or temporary recording medium that stores various programs and data. The storage device 102 includes a read only memory (ROM), a random access memory (RAM), a hard disk drive (HDD), and a flash memory. The input device 103 inputs data. The input device 103 includes a keyboard, a mouse, a touch panel, a numeric keypad, a scanner, a microphone, and a sensor. The output device 104 outputs data. The output device 104 includes a display, a printer, and a speaker. The communication IF 105 connects to a network and transmits and receives data.

### <Example of Functional Configuration of Classification Device 100>

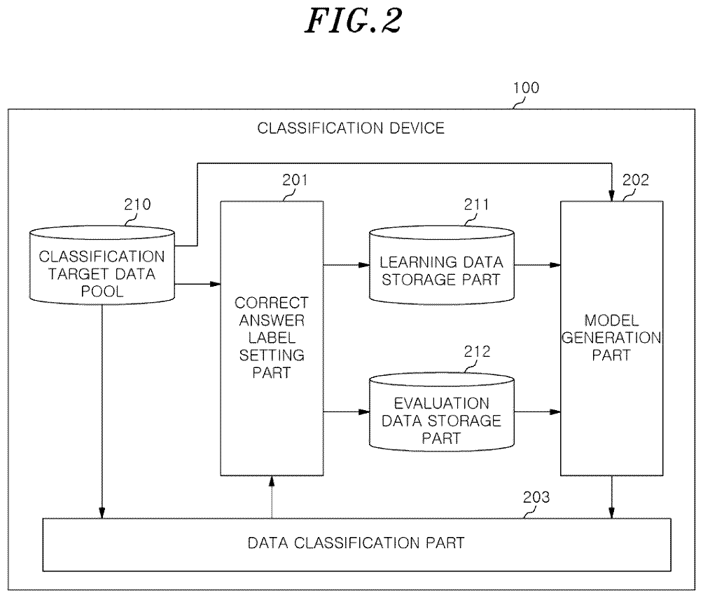

FIG. 2 is a block diagram showing an example of a functional configuration of the classification device 100. The classification device 100 is a computer that supports data classification, and includes a correct answer label setting part 201, a model generation part 202, a data classification part 203, a classification target data pool 210, a learning data storage part 211, and an evaluation data storage part 212.

Specifically, the correct answer label setting part 201, the model generation part 202, and the data classification part 203 are realized by causing the processor 101 to execute a program stored in the storage device 102 shown in FIG. 1, for example. Further, the classification target data pool 210, the learning data storage part 211, and the evaluation data storage part 212 are realized by the storage device 102 shown in FIG. 1.

The classification target data pool 210 is database that stores the classification target data. The classification target data may be image data or text data. A correct answer label is not attached to the classification target data.

The learning data storage part 211 is database that stores learning data. The learning data is classification target data (except evaluation data) that is randomly classified from the classification target data pool 210 whenever the model generation part 202 learns a prediction model (hereinafter, simply referred to as “model”) M. A correct answer label is attached to the learning data. The evaluation data is classification target data used for the performance evaluation of the model M by the model generation part 202, and is classified in advance from the classification target data pool 210. A correct answer label is attached to the evaluation data.

The correct answer label setting part 201 extracts classification target data from the classification target data pool 210, and sets such that a correct answer label can be attached to the extracted classification target data. Specifically, the correct answer label setting part 201 displays the extracted classification target data, for example. When the input of the correct label is accepted by a user's operation, the learning data to which the correct label is attached and the evaluation data to which the correct label is attached are set.

The model generation part 202 inputs the learning data to which the correct label is attached, which is stored in the learning data storage part 211, and generates the model M that performs prediction. Further, the model generation part 202 performs prediction using the generated model M for the evaluation data stored in the evaluation data storage part 212. The model generation part 202 calculates a performance evaluation value of the model M by regarding the magnitude of the difference between the correct label and the prediction result as the performance of the model M. The performance evaluation value of the model M increases as the difference between the correct label and the prediction result decreases.

The data classification part 203 classifies data to be additionally learned (hereinafter, referred to as “additional learning data”) from the classification target data pool 210 based on the prediction result by the model generation part 202. The data classification part 203 requests the correct label setting part 201 to set a correct label for the additional learning data classified from the classification target data pool 210. In this case, the correct label setting part 201 that has received the request sets a correct label for the additional learning data classified by the data classification part 203.

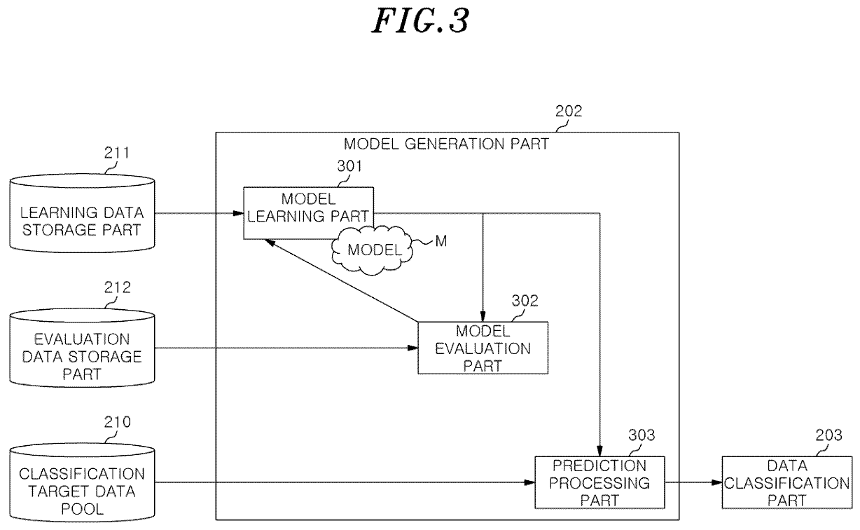

FIG. 3 is a block diagram showing a specific functional configuration of the model generation part 202. The model generation part 202 has a model learning part 301, a model evaluation part 302, and a prediction processing part 303. The model learning part 301 inputs learning data to which the correct label is attached, which is stored in the learning data storage part 211, and learns the model M that performs prediction.

The model evaluation part 302 inputs the evaluation data to which the correct answer label is attached, which is stored in the evaluation data storage part 212, and evaluates the model M generated by the model learning part 301. Specifically, the model evaluation part 302 calculates a performance evaluation value based on a loss function from the difference between the output data outputted as a result of inputting the evaluation data to the model M and the correct answer label attached to the evaluation data, for example. The higher performance evaluation value indicates the better performance, for example. The performance evaluation value is transmitted to the model learning part 301, and the model learning part 301 re-learns the model M so that the performance evaluation value increases.

The prediction processing part 303 executes a prediction process on the classification target data stored in the classification target data pool 210 using the model M generated by the model learning part 301, and outputs the prediction result. The data classification part 203 classifies the classification target data based on the prediction result outputted by the prediction processing part 303.

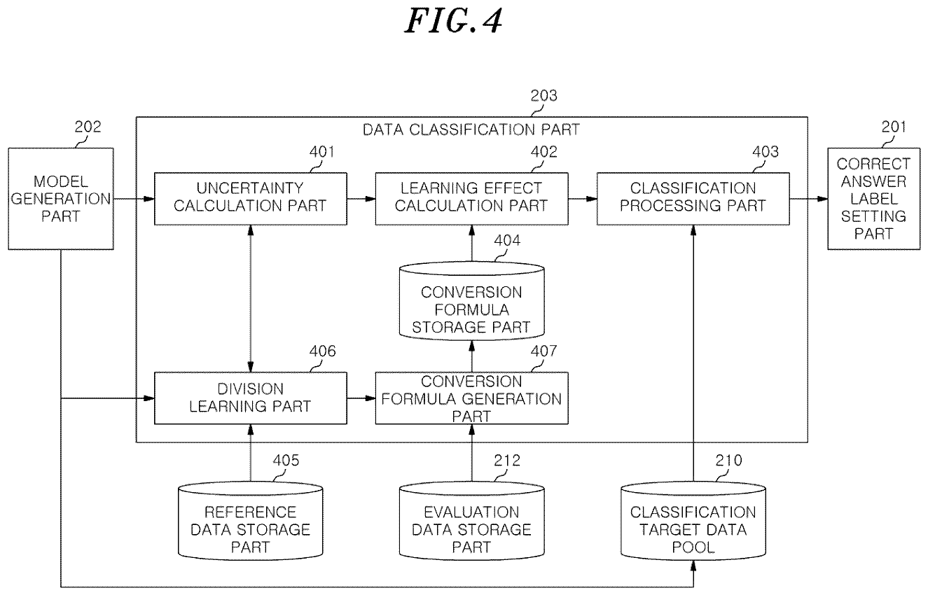

FIG. 4 is a block diagram showing a specific functional configuration of the data classification part 203 according to Test example 1. As shown in FIG. 4, the data classification part 203 includes an uncertainty calculation part 401, a learning effect calculation part 402, a classification processing part 403, a conversion formula storage part 404, a reference data storage part 405, a division learning part 406, and a conversion formula generation part 407. Specifically, the uncertainty calculation part 401, the learning effect calculation part 402, the classification processing part 403, the division learning part 406, and the conversion formula generation part 407 are realized by causing the processor 101 to execute a program stored in the storage device 102 shown in FIG. 1, for example. The conversion formula storage part 404 and the reference data storage part 405 are realized by the storage device 102 shown in FIG. 1.

The uncertainty calculation part 401 calculates uncertainty indicating a degree of doubt of the prediction result based on the prediction result outputted by the model generation part 202, as disclosed in Patent Document 2, for example. A degree of doubt is an index indicating the ambiguity of the prediction result of the data by the model M. The uncertainly indicates a degree of doubt.

In other words, the uncertainty is an evaluation value for determining whether the certainty of the prediction result by the generated model M is high or low, and is correlated with the learning effect. In general, when the uncertainty is high, the prediction result of the classification target data by the model M is uncertain, and it is determined that the classification target data is data with high necessity of additional learning. On the other hand, the uncertainty is low, the prediction result of the classification target data by the model M for the classification target data is certain, and it is determined that the classification target data is data with low necessity of additional learning.

Specifically, the uncertainty is, e.g., low probability (=prediction result) of the correct answer label with the highest probability, a probability difference between the correct answer label with the highest probability and the correct answer label with the second highest probability, a magnitude of the entropy of the prediction distribution of the model M, or the like.

The learning effect calculation part 402 calculates a learning effect evaluation value based on the conversion formula stored in the conversion formula storage part 404 from the uncertainty calculated by the uncertainty calculation part 401. The learning effect evaluation value is a value that evaluates the learning effect that contributes to the improvement of the performance of the model M. In other words, the learning effect evaluation value is an evaluation value indicating that the performance is improved (i.e., there is a learning effect) when the classification target data to which no correct answer label is attached is used for additional learning of the model M. The classification target data with a higher learning effect evaluation value indicates that it should be classified as additional learning data.

The classification processing part 403 classifies the classification target data stored in the classification target data pool 210 as additional learning data or non-additional learning data based on the learning effect evaluation value. Specifically, for example, if the learning effect evaluation value from the learning effect calculation part 402 is greater than or equal to a threshold, the classification processing part 403 classifies the classification target data corresponding to the prediction result used for calculating the learning effect evaluation value as additional learning data. If the learning effect evaluation value is not greater than or equal to the threshold, the classification processing part 403 classifies the classification target data as non-additional learning data. Further, the classification processing part 403 requests the correct answer label setting part 201 to set a correct answer label for the additional learning data.

Further, the classification processing part 403 may delete the classification target data (i.e., non-additional learning data) in which the correct answer label setting part 201 is not requested to perform correct answer label setting from the classification target data pool 210. Accordingly, the memory used by the classification target data pool 210 can be reduced.

The conversion formula storage part 404 stores a conversion formula. The conversion formula converts the uncertainty of an arbitrary prediction result into a learning effect evaluation value indicating the level of learning effect when the model M is learned using the classification target data. The conversion formula is used for eliminating classification target data with low learning effect, such as outlier data deviated from the classification target data group in the classification target data pool 210 or to the classification target data to which an erroneous correct answer label is attached, even if the classification target data has high uncertainty.

Such classification target data is determined to have a low learning effect evaluation value by the conversion formula even if it has high uncertainty. Further, the learning effect evaluation value is calculated to be high for classification target data other than the classification target data with high uncertainty and a low learning effect. Therefore, even when the classification target data pool 210 includes classification target data that should not be used for additional learning, it is possible to accurately classify the classification target data with high necessity of additional learning.

The reference data storage part 405 stores reference data. The reference data is data extracted from the classification target data pool 210. Similarly to the learning data, a correct answer label is attached to the reference data.

The division learning part 406 acquires the model M generated by the model generation part 202. The division learning part 406 inputs the reference data stored in the reference data storage part 405 to the acquired model M and outputs a prediction result. The division learning part 406 outputs the prediction result to the uncertainty calculation part 401, and causes the uncertainty calculation part 401 to calculate the uncertainty of the prediction result. The division learning part 406 acquires the uncertainty for each prediction result, and divides the reference data group into multiple batches based on the uncertainty. The division learning part 406 performs additional learning of the model M using the batches.

The conversion formula generation part 407 generates the conversion formula for converting the uncertainty into a learning effect evaluation value from the correlation between an average uncertainty of the reference data included in the batches in the division learning part 406 and the performance evaluation value of the model for each batch that is additionally learned in the division learning part 406, and stores the conversion formula in the conversion formula storage part 404.

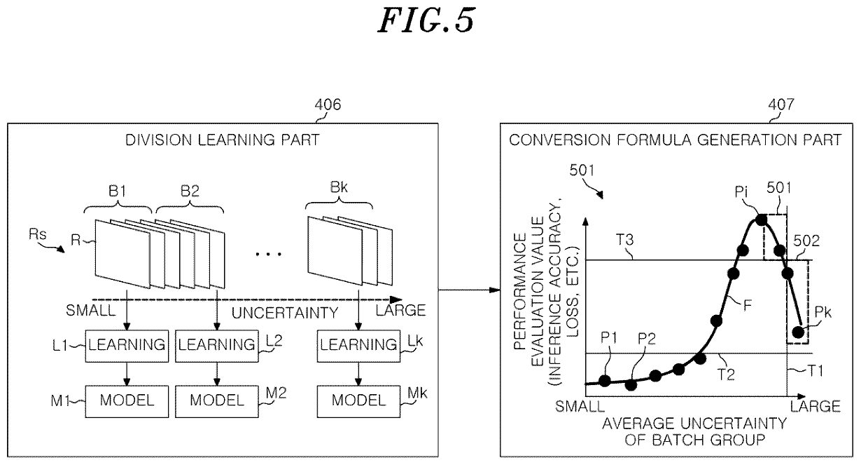

FIG. 5 is an explanatory diagram showing a specific example of the division learning part 406 and the conversion formula generation part 407. The division learning part 406 outputs each reference data R of a reference data group Rs stored in the reference data storage part 405 to the uncertainty calculation part 401, and acquires the uncertainty of each reference data R from the uncertainty calculation part 401.

The division learning part 406 arranges the reference data R in an ascending order of the uncertainty of each reference data R, and divides the arranged reference data group Rs into k-number of batches B1 to Bk (k being an integer of 2 or more). When the batches B1 to Bk are not distinguished, they are referred to as batch Bi (i being an integer that satisfies 1≤i≤k).

For example, when the number of reference data R is N and k-number of batches are generated, the reference data R are arranged in a decreasing order of the uncertainty. The first to N/k^{th} reference data R are set as the first batch B1. The (N/k+1)^{th} to 2N/k^{th} reference data R are set as the second batch B2. In this manner, the reference data group Rs is divided into the k-number of batches B1 to Bk. Then, additional learning L1 to Lk of the model M is performed using the generated batches B1 to Bk, thereby generating models M1 to Mk of which number is the same as that of the batches k.

The conversion formula generation part 407 calculates the average uncertainty of the reference data R included in each of the batches B1 to Bk used in the additional learning L1 to Lk of the models M1 to Mk in the division learning part 406. Here, the average value of the uncertainty of the reference data R is calculated. However, a representative value (representative uncertainty) such as a maximum value, a minimum value, or a median value of the uncertainty in the batch Bi may be used other than the average value.

Further, similarly to the model evaluation part 302, the conversion formula generation part 407 calculates the performance evaluation values of the models M1 to Mk using the evaluation data. Then, the conversion formula generation part 407 calculates data points P1 to Pk for the batch Bi based on the correlation between the average uncertainty of the reference data R and the performance evaluation value of the model Mi, generates a conversion formula F that converts the uncertainty into a performance evaluation value by fitting the calculated data points P1 to Pk, and stores the conversion formula F in the conversion formula storage part 404.

Specifically, for example, the conversion formula generation part 407 plots the data points P1 to Pk on a graph 500 with the horizontal axis representing the average uncertainty of the batch Bi and the vertical axis representing the performance evaluation value of the model Mi after learning Li, and generates the conversion formula F by polynomial approximation. The performance evaluation value of the model Mi, which has additionally learned the batches Bi including a large number of reference data R with high learning effect evaluation values, is further improved. Therefore, the output obtained in the case of inputting the uncertainty into the conversion formula F generated by the correlation between the average uncertainty of the batch Bi and the performance evaluation value of the model Mi is outputted, as the learning effect evaluation value for evaluating the learning effect, to the data classification part 203.

Further, in the conversion formula F shown in FIG. 5, the performance evaluation value increases as the average uncertainty increases for the data points P1 to Pi. Beyond the data point Pi, such relationship is not applied and the performance evaluation value decreases. Since, however, the performance evaluation value is high in a region 501, the classification target data with high uncertainty and a high learning effect evaluation value can be classified as additional learning data for the data points in the region 501.

Specifically, for example, if the uncertainty is less than or equal to a first threshold value T1 and the learning effect evaluation value outputted from the conversion formula F is greater than or equal to a second threshold value T2, the classification target data is classified as additional learning data. Accordingly, it is possible to suppress the omission of classification of the classification target data with a high learning effect evaluation value, and to suppress erroneous detection such as classification of the classification target data with a low learning effect evaluation value as additional target data, for example.

Further, when the average uncertainty increases from a region 501 toward a region 502, the performance evaluation value decreases further. Therefore, the classification device 100 can exclude such classification target data from the classification target to avoid it from being used in additional learning.

Specifically, for example, if the uncertainty is greater than the first threshold T1 and the learning effect evaluation value outputted from the transformation formula F is less than or equal to a third threshold T3 (>T2), the classification target data is classified as non-additional learning data. Accordingly, the classification target data containing a target object that is not clear (e.g., an out-of-focus image) or the classification target data with occlusion can be classified the classification target data with high uncertainty and a low learning effect evaluation value, and excluded from classification target.

### <Data Classification Process>

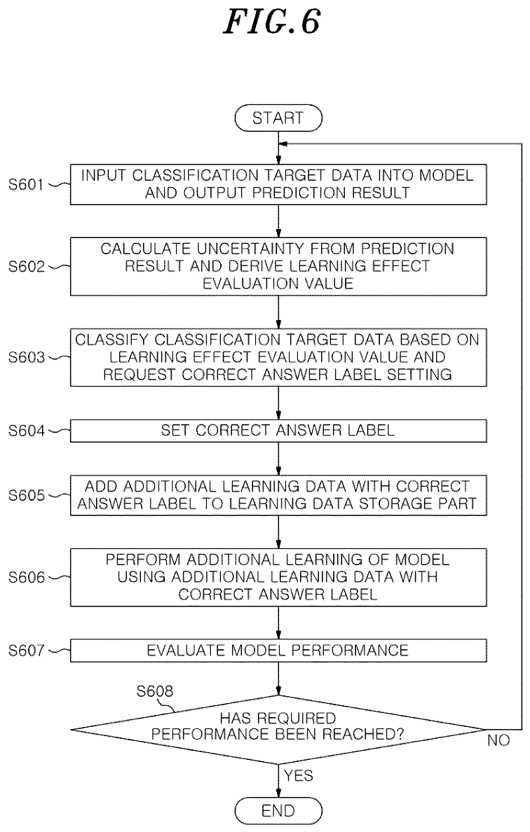

FIG. 6 is a flowchart showing an example of a sequence of a data classification process performed by the classification device 100 according to Test example 1. First, the prediction processing part 303 performs prediction on the data in the classification target data pool 210 using the model M generated by the model learning part 301, and outputs the prediction result (step S601).

Next, the uncertainty calculation part 401 inputs the prediction result, and calculates the uncertainty of the prediction result. Further, the learning effect calculation part 402 inputs the uncertainty into the conversion formula stored in the conversion formula storage part 404, and calculates a performance evaluation value (step S602).

Then, the classification processing part 403 classifies the classification target data in the classification target data pool 210 as additional learning data based on the converted performance evaluation value, and requests the correct answer label setting part 201 to set a correct answer label for the classified additional learning data (step S603).

As described above, the performance of the model Mi that has additionally learned the batch Bi including a large number of reference data R with a high learning effect is improved, so that the calculated performance evaluation value serves as the learning effect evaluation value. Therefore, the classification processing part 403 can classify the classification target data as additional learning data based on the learning effect evaluation value that is the calculated performance evaluation value. In this manner, as the learning effect evaluation value increases, the classification target data is more likely to be classified as the additional learning data, and as the learning effect evaluation value decreases, the classification target data is more likely to be classified as the non-additional learning data.

The correct label setting part 201 executes correct label setting (step S604). Specifically, for example, the correct label setting part 201 displays the additional learning data, accepts the input of the correct label from a user, and correlates the inputted correct label with the additional learning data (step S604).

After step S604, the correct label setting part 201 adds the additional learning data to which the correct label is attached to the learning data storage part 211 (step S605). The model generation part 202 updates the model M by causing the model learning part 301 to perform additional learning of the model M using the additional learning data to which the correct answer label is attached (step S606).

The model evaluation part 302 evaluates the performance of the updated model M using the evaluation data stored in the evaluation data storage part 212 for the updated model M (step S607). If the performance of the model M has reached the required performance as a result of evaluation (step S608: Yes), the model evaluation part 302 ends the data classification process. If the performance has not reached the required performance (step S608: No), the model evaluation part 302 executes the data classification process again from step S601.

In this manner, in the data classification process shown in FIG. 6, the learning effect evaluation value of each data can be accurately calculated, and data with a high learning effect evaluation value is classified. Accordingly, the model M can be efficiently learned.

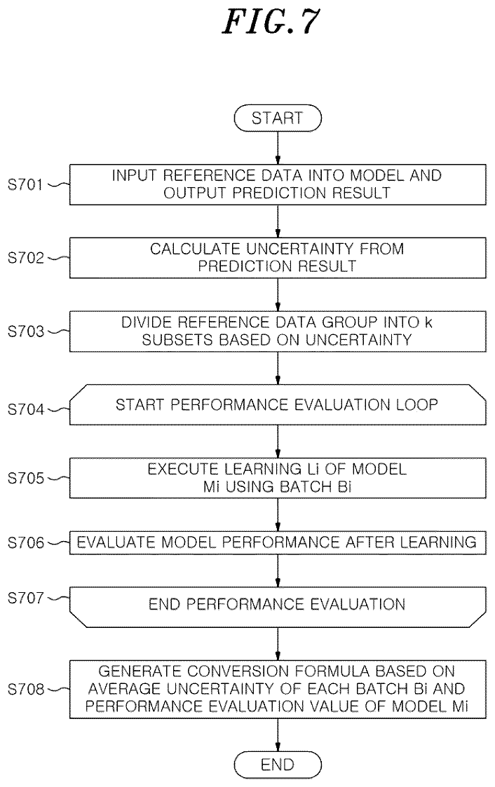

FIG. 7 is a flowchart showing an example of a sequence of conversion formula generation process performed by the division learning part 406 and the conversion formula generation part 407. First, the division learning part 406 inputs the reference data R stored in the reference data storage part 405 into the model M and outputs a prediction result for each reference data R (step S701).

Then, the division learning part 406 causes the uncertainty calculation part 401 to calculate the uncertainty based on the prediction result for each reference data R, and acquires the uncertainty for each reference data R from the uncertainty calculation part 401 (step S702). Further, the division learning part 406 divides the reference data group Rs into the k-number of batches B1 to Bk based on the uncertainty for each reference data R (step S703).

Then, the division learning part 406 starts a performance evaluation loop (step S704). Specifically, for example, the division learning part 406 initializes i to 1, and executes steps S705 and S706. If it is determined in step S707 that the performance evaluation is not ended, the division learning part 406 increases i in step S701 and executes steps S705 and S706 for the increased i.

In step S707, the division learning part 406 determines whether i is k or not. If i is not k, it is determined that the performance evaluation is not ended, and the processing proceeds to step S704. On the other hand, if i is k, it is determined that the performance evaluation of the models M1 to Mk is ended, and the processing proceeds to step S708.

In steps S705 and S706 in an i^{th} loop, the division learning part 406 executes the learning Li of the model Mi using the batch Bi (step S7005), evaluates the performance of the model Mi after learning (step S706), and proceeds to step S70.

When it is determined in step S707 that the performance evaluation of the models M1 to Mk is ended, the conversion formula generation part 407 calculates the average uncertainty by averaging the uncertainly for the reference data included in each batch Bi, generates, for each batch Bi, the conversion formula F based on the correlation between the average uncertainty of the batch Bi and the performance evaluation value of the model Mi that has performed the learning Li in the batch Bi, and stores the conversion formula F in the conversion formula storage part 404 (step S708). Hence, the conversion formula generation process is ended.

The performance evaluation value of the model Mi that has additionally learned the batch Bi including a large number of reference data R with a high learning effect evaluation value is improved further. Since the output obtained in the case of inputting the uncertainty into the conversion formula F generated from the correlation between the average uncertainty of the batch Bi and the performance evaluation value of the model Mi is used as the learning effect evaluation value for evaluating the learning effect, it is possible to accurately classify the classification target data using the learning effect evaluation value.

### Test Example 2

Test example 2 will be described. In Test example 2, the classification target data that is unnecessary in Test example 1 is set to be excluded from the classification target. Like reference numerals will be used for like parts as those in Test example 1, and the description thereof will be omitted.

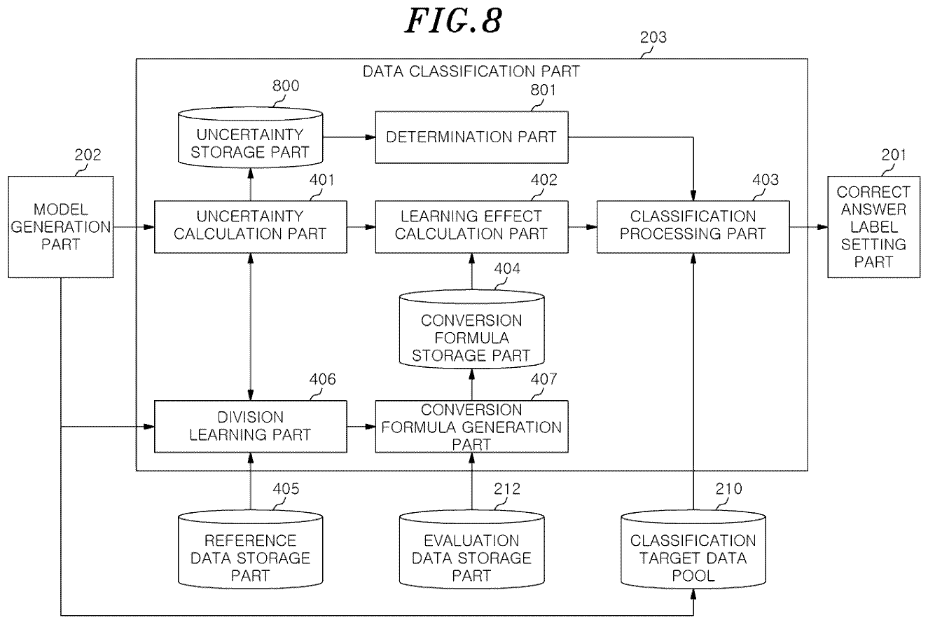

FIG. 8 is a block diagram showing a specific functional configuration of the data classification part 203 according to Test example 2. As shown in FIG. 8, the data classification part 203 has an uncertainty storage part 800 and a determination part 801. Specifically, the determination part 801 is realized by causing the processor 101 to execute a program stored in the storage device 102 shown in FIG. 1, for example. The uncertainty storage part 800 is realized by the storage device 102 shown in FIG. 1.

The uncertainty storage part 800 stores the uncertainty before and after the additional learning of the model M calculated by the uncertainty calculation part 401 for each classification target data.

The determination part 801 calculates the amount of change in the uncertainty for each classification target data before and after additional learning based on the uncertainty stored in the uncertainty storage part 800. Specifically, for example, the determination part 801 calculates the amount of change for each classification target data by subtracting the uncertainty before learning from the uncertainty after learning. The classification target data with a large amount of change is more likely to become outlier data whose prediction accuracy is not improved even if the additional learning is performed.

The determination part 801 determines the classification target data to be excluded from the classification target based on the amount of change. Specifically, for example, the classification processing part 403 determines that the classification target data whose amount of change is greater than or equal to a threshold value is outlier data whose prediction accuracy is not improved even if the additional learning is performed, and determines the classification target data to be excluded from the classification target.

Further, the determination part 801 may determine the classification target data in the order of first to nth magnitudes of the amount of change among the classification target data group in which the change amount and the learning effect evaluation value (performance evaluation value) have been calculated as outlier data in which prediction is not improved even if the additional learning is performed, and may set the classification target data to be excluded from the classification target.

The determination part 801 outputs the classification target data that is not set to be excluded from the classification target (classification target data that is not outlier data) to the classification processing part 403. Further, the determination part 801 may set the classification target data to be excluded from the classification target by deleting the classification target data determined to be outlier data. Accordingly, the memory used by the determination part 801 can be reduced.

Further, the determination part 801 or the classification processing part 403 may attach an outlier label indicating an outlier data to the outlier data, and overwrite and save it in the classification target data pool 210. In this case, the classification processing part 403 does not extract the classification target data with the outlier label. Accordingly, it is possible to prevent the extraction of the classification target data of which prediction accuracy is not improved even if the additional learning is performed.

Further, the determination part 801 or the classification processing part 403 may delete the classification target data that is determined to be the outlier data by the determination part 801 from the classification target data pool 210. Accordingly, it is possible to prevent the extraction of the classification target data whose prediction accuracy is not improved even if the additional learning is performed. It is also possible to reduce the memory used by the classification target data pool 210.

### <Data Classification Process>

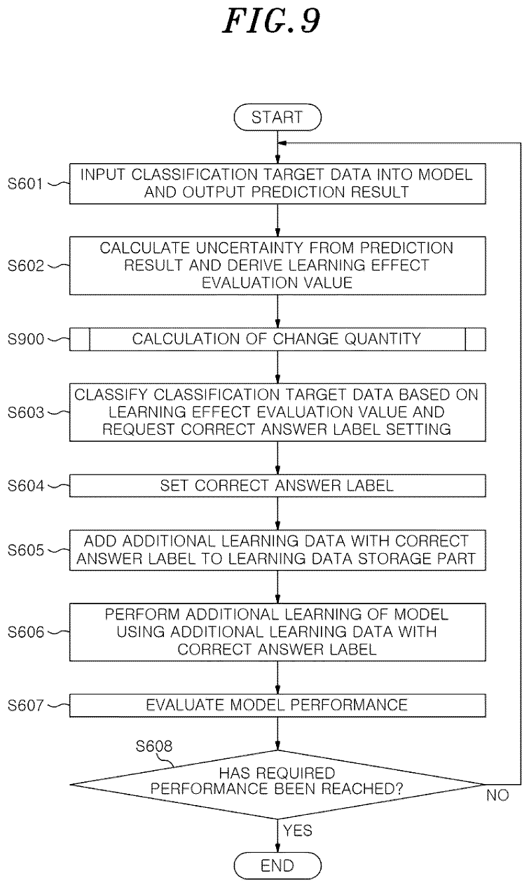

FIG. 9 is a flowchart showing an example of a sequence of a data classification process performed by the classification device 100 according to Test example 2. After step S602, the determination part 801 executes a determination process (step S900) and proceeds to step S603.

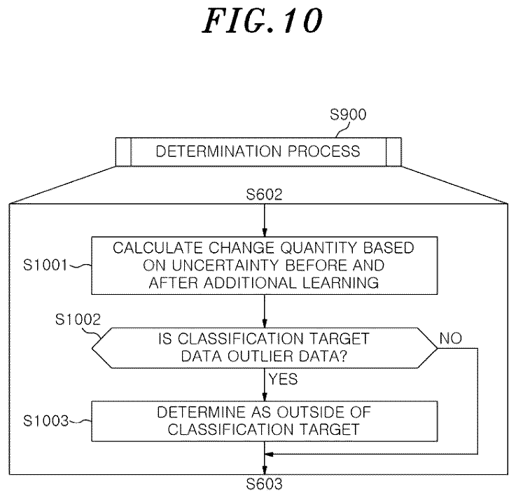

FIG. 10 is a flowchart showing a specific example of the determination process (step S900) performed by the determination part 801. When the classification target data is inputted, the determination part 801 calculates the amount of change based on the uncertainty before and after the additional learning (step S1001).

The determination part 801 determines whether or not each classification target data is the outlier data based on the amount of change (step S1002). If it is the outlier data (step S1002: Yes), the determination part 801 determines the classification target data to be excluded from classification (step S1003) and proceeds to step S603. On the other hand, if it is not the outlier data (step S1002: No), the processing proceeds to step S603.

In this manner, in accordance with Test example 2, it is possible to accurately select classification target data with a high learning effect evaluation value.

Further, in Test examples 1 and 2 described above, the conversion formula generation part 407 generates the conversion formula F. However, the conversion formula F may be stored in advance in the conversion formula storage part 404.

Further, the model generation part 202, the classification target data pool 210, the learning data storage part 211, the evaluation data storage part 212, the reference data storage part 405, and the uncertainty calculation part 401 are not necessarily realized in the classification device 100, and may be realized in a computer outside the classification device 100 that can be accessed by the classification device 100 via a network such as the Internet, a local area network (LAN), a wide area network (WAN), or the like.

Further, in Test examples 1 and 2 described above, the prediction model may be a two-class classifier (e.g., distinguishing whether it is a person or not) or a three-class or more multi-class classifier (e.g., distinguishing whether it is a male, a female, or neither).

As described above, in accordance with the classification device 100 described above, it is possible to accurately classify the classification target data that is effective for learning as the additional learning data based on the uncertainty of the prediction result outputted by the model M for the inputted classification target data. Therefore, efficient additional learning can be performed using additional learning data with high learning effect.

Further, the present disclosure is not limited to the above-described embodiments, and includes various modifications and equivalent configurations within the spirit of the appended claims. For example, the above-described embodiments have been described in detail to make the present disclosure easily understood, and the present disclosure does not necessarily include all the described configurations. Further, a part of the configuration of one embodiment may be replaced with the configuration of another embodiment. Further, a configuration of another embodiment may be added to the configuration of one embodiment. Further, a part of the configuration of each embodiment may be added, deleted, or replaced by another configuration.

Further, some of all of the configurations, functions, processing parts, processing devices and the like described above may be implemented by hardware, such as an integrated circuit designed for these configurations and the like, or may be implemented by software under a program interpreted and executed by a processor for implementing each of the functions.

Information such as a program, a table, a file or the like which implements each of the functions can be stored in a storage device such as a memory, a hard disk, a solid state drive (SSD), or a recording medium such as an integrated circuit (IC) card, a secure digital memory (SD) card, and a digital video disk (DVD).

Further, control lines and information lines indicate only those considered to be necessary for explanation, and not necessarily indicate all control lines and information lines formed on a product. In practice, it may be considered that almost all configurations are mutually connected.

1. A classification device that includes a processor that executes a program and a storage device that stores the program, and is accessible to a group of learning data to which a correct answer label is attached,
wherein the processor executes:
a calculation process for calculating a first learning effect evaluation value indicating the extent to which the classification target data contributes to additional learning of the prediction model based on first uncertainty indicating a level of ambiguity of a first prediction result outputted as a result of inputting classification target data to which the correct answer label is not attached to a prediction model learned with the group of learning data;
a classification process for classifying the classification target data as additional learning data or non-additional learning data for the prediction model based on the first learning effect evaluation value calculated by the calculation process;
a setting process for performing setting such that the correct answer label is attached to the additional learning data classified by the classification process; and
an addition process for adding the additional learning data to which the correct answer label is attached by the setting process to the group of learning data,
wherein in the calculation process, the processor calculates the first learning effect evaluation value by inputting the first uncertainty into a conversion formula for converting the first uncertainty into the first learning effect evaluation value,
wherein the classification device is accessible to a group of reference data to which a correct answer label is attached,
the processor executes:
a division learning process for dividing the group of reference data into a plurality of subsets based on second uncertainty indicating a level of ambiguity of a second prediction result for each of the reference data outputted as a result of inputting each reference data of the group of reference data into the prediction model, additionally learning the prediction model for each of the subsets, and calculating a performance evaluation value of the prediction model after the additional learning for each of the subsets; and
a generation process for generating the conversion formula based on a representative value of the second uncertainty for each of the subsets and the performance evaluation value for each of the subsets calculated by the division learning process, and
in the calculation process, the processor calculate the first learning effect evaluation value by inputting the first uncertainty into the conversion formula generated by the generation process.

2. The classification device of claim 1, wherein in the division learning process, the processor divides the group of reference data into the plurality of subsets, with a certain number of the reference data in the order of a magnitude of the second uncertainty as a unit of the subsets.

3. The classification device of claim 1, wherein in the generation process, the processor generates the conversion formula based on correlation between a representative value of the second uncertainty for each of the subsets and the performance evaluation value for each of the subsets.

4. A classification device that includes a processor that executes a program and a storage device that stores the program, and is accessible to a group of learning data to which a correct answer label is attached,
wherein the processor executes:
a calculation process for calculating a first learning effect evaluation value indicating the extent to which the classification target data contributes to additional learning of the prediction model based on first uncertainty indicating a level of ambiguity of a first prediction result outputted as a result of inputting classification target data to which the correct answer label is not attached to a prediction model learned with the group of learning data;
a classification process for classifying the classification target data as additional learning data or non-additional learning data for the prediction model based on the first learning effect evaluation value calculated by the calculation process;
a setting process for performing setting such that the correct answer label is attached to the additional learning data classified by the classification process; and
an addition process for adding the additional learning data to which the correct answer label is attached by the setting process to the group of learning data,
wherein in the classification process, the processor classifies, as the additional learning data, the classification target data in which the first uncertainty is less than or equal to a first threshold value and the first learning effect evaluation value is greater than or equal to a second threshold value.

5. A classification device that includes a processor that executes a program and a storage device that stores the program, and is accessible to a group of learning data to which a correct answer label is attached,
wherein the processor executes:
a calculation process for calculating a first learning effect evaluation value indicating the extent to which the classification target data contributes to additional learning of the prediction model based on first uncertainty indicating a level of ambiguity of a first prediction result outputted as a result of inputting classification target data to which the correct answer label is not attached to a prediction model learned with the group of learning data;
a classification process for classifying the classification target data as additional learning data or non-additional learning data for the prediction model based on the first learning effect evaluation value calculated by the calculation process;
a setting process for performing setting such that the correct answer label is attached to the additional learning data classified by the classification process; and
an addition process for adding the additional learning data to which the correct answer label is attached by the setting process to the group of learning data,
wherein the processor executes a determination process for determining the classification target data to be excluded from a classification target based on a difference between the first uncertainty outputted as a result of inputting the classification target data into the prediction model before the addition by the addition process and third uncertainty outputted as a result of inputting the classification target data to the prediction model that is additionally learned with the group of learning data after the addition by the addition process,
in the calculation process, the processor calculates a second learning effect evaluation value indicating the extent to which the classification target data contributes to additional learning of the prediction model after the additional learning based on the third uncertainty,
in the classification process, the processor classifies the classification target data that is not determined to be excluded from the classification target by the determination process as additional learning data or non-additional learning data of the prediction model after the additional learning based on the second learning effect evaluation value.

6-12. (canceled)
